(19) United States
(12) Patent Application Publication
(10) Pub. No.: US 2026/0201513 A1
(43) Pub. Date: Jul. 16, 2026

(54) HOT ROLLING WITH RESIDUAL ELEMENTS

(71) Applicant: ArcelorMittal, Luxembourg (LU)

(72) Inventors: Thierry IUNG, Jarny (FR); Ronan JACOLOT, Landonvillers (FR)

(21) Appl. No.: 19/133,140

(22) PCT Filed: Dec. 1, 2023
(86) PCT No.: PCT/IB2023/062110

§ 371 Date: May 27, 2025

(30) Foreign Application Priority Data
Dec. 2, 2022 (WO) PCT/IB2022/061683

(51) Int. Cl. C22C 33/04; C21C 5/56; C21D 7/13; C22C 38/00; C22C 38/04; C22C 38/12; C22C 38/60

(52) U.S. Cl. CPC C22C 33/04; C21C 5/562; C21D 7/13; C22C 38/002; C22C 38/008; C22C 38/04; C22C 38/12; C22C 38/60

(57) ABSTRACT

A method of manufacturing a hot rolled steel product is provided having a composition in weight percent being: 0.002≤C≤0.8, 0.1≤Mn≤12.0, Si≤2, Al≤2, Cr≤0.5, Nb≤0.08, Ti≤0.1 and a balance consisting of Fe, residual elements and unavoidable impurities, including the steps of i. acquiring an initial target composition with a content of manganese Mn_{t,i}, ii. melting steel scraps comprising residual elements, iii. estimating the contents Mn₀, Mo₀, Sn₀, Sb₀ or As₀, iv. determining an adjusted target composition with an adjusted content of manganese Mn_{t,a} where Mn_{t,a}=Mn_{t,I}−Mn_{RES} with Mn_{RES} an adjustment term which combines corrective terms associated to the residual elements, v. adding elements to the steel melt so that Mn₀+Mn_{ADD}=Mn_{t,a}, wherein Mn_{ADD} represents the content of manganese added, vi. casting a semi-finished product, vii. hot rolling the semi-finished product.

This invention relates to an elaboration method of a steel to be hot rolled, wherein the steel is elaborated using steel scraps.

### BACKGROUND

Steelmaking requires the use of iron-containing material, such as steel scraps, direct reduced iron or pig iron. In order to reduce the carbon footprint of the steel industry, the use of steel scraps is seen as key. However, steel scraps contain residual elements, such as copper, chromium, molybdenum, nickel, tin, antimony, zinc and/or arsenic. The use of steel scraps is therefore not widely spread for all steel grades as those residual elements can have a detrimental effect on the steel properties.

During the steel elaboration by means of direct reduced iron and/or pig iron, small amounts of residual elements are inevitably left behind in the liquid steel. When using steel scraps, the amount of residual elements is much greater compared to pig iron coming from a blast furnace or direct reduced iron.

### SUMMARY OF THE INVENTION

It has been recently observed by the present inventors that the production of steel using significant amount of steel scraps is raising issues during some manufacturing steps like hot rolling for example.

It is an object of the present invention to increase the hot rolling processability of a semi-finished steel product made, at least partly, from steel scraps comprising the following residual elements: molybdenum, tin, antimony, arsenic.

The present invention provides a method of manufacturing a hot rolled steel product having a composition in weight percent being: 0.002≤C≤0.8, 0.1≤Mn≤12.0, Si≤2, Al≤2, Cr≤0.5, Nb≤0.08, Ti≤0.1 and a balance consisting of Fe, one or more residual elements and unavoidable impurities, wherein said one or more residual elements comprise one or more of Mo, Sn, Sb, As, and wherein said method comprises the steps of:
i. acquiring an initial target composition which specifies an initial target content of manganese Mn_{t,i},
ii. melting steel scraps comprising at least one of said one or more residual elements and optionally hot metal and/or direct reduced iron so as to form a steel melt
iii. estimating an estimated content of manganese Mn₀ in the steel produced in step ii, and for each of the one or more residual elements: estimating an estimated residual content Mo₀, Sn₀, Sb₀ or As₀ of the steel melt produced in step ii.,
iv. determining an adjusted target composition which specifies an adjusted target content of manganese Mn_{t,a} where Mn_{t,a}=Mn_{t,I}−Mn_{RES} with Mn_{RES} an adjustment term which combines one or more corrective terms respectively associated to the one or more residual elements, the higher the estimated residual content for the residual element considered, the higher the corrective term, each corrective term being at least equal to the estimated residual content for the residual element considered Mo₀, Sn₀, Sb₀ or As₀.
v. adding elements to the steel melt so that Mn₀+Mn_{ADD}=Mn_{t,a}, wherein Mn_{ADD} represents the content of manganese added,
vi. casting a semi-finished product with said liquid steel, and
vii. hot rolling said semi-finished product.

The hot rolling permits to reduce the thickness of a slab in order to obtain a desired geometry. This will entail the person skilled in the art to determine an optimal rolling pattern (i.e. number of rolling pass, rolling reduction) while taking into account metallurgical (i.e. steel temperature) and equipment constraints (i.e. couple, speed, force, applicable stress).

Consequently, those parameters allow to establish, for each rolling pass, pre-sets for the rolling stands. For example, it is possible to define a reduction rate to apply at each rolling stand that applies a mean flow stress on the product. The mean flow stress is equal to the area under the stress-strain curve from a strain Sa to a strain sp.

However, in the state of the art, the content of residual elements from steel scrap is not taken into account when establishing the rolling pattern and thus the pre-sets.

Moreover, it has surprisingly been found that the presence of specific residual elements coming from the steel scraps, namely Mo, Sn, Sb and As, lead to a deviation from the theoretical stress-strain curve because the theoretical stress-strain curve is defined without taking into consideration said residual elements. This deviation leads to a change of the mean flow stress resulting from the necessary deformation applied during the hot rolling, to achieve the target reduction rate.

As all the hot rolling parameters are defined using an adapted pre-set, when applying a target reduction rate during the hot rolling of a steel elaborated from steel scrap containing said residual elements, the mean flow stress applied deviates from the theoretical mean flow stress to achieve the target strain rate.

This deviation can lead to processability issue and possibly to an accelerated degradation of the rolling cylinder because the real stress applied by the hot rolling stand is higher than the expected one and can exceed the maximum stress allowed for the rolling cylinders.

In order to counter this surprising effect of the residual elements, the inventors proposed to adjust the composition of the final product by defining an equivalent content of manganese Mn_{RES}, having the same impact, as the content of said residual elements, on an increase of the mean flow stress resulting from the deformation applied during a hot rolling pass. Preferably, during the last pass of said hot rolling. Mn_{RES} is an adjustment term which combines one or more corrective terms respectively associated to the residual elements.

Consequently, the manganese content added during the composition adjustment, and thus the manganese content in the final product, is lower due to the equivalent content of manganese Mn_{RES}, taking into account the effect of residuals.

It allows to counter the deviation of the mean flow stress, resulting from the deformation applied during the hot rolling, due to the presence of said residual elements. In other words, it permits to obtain a steel with an adjusted content in manganese and with residuals that has the same mean flow stress than a steel with an initial content in manganese and without residuals. The initial content in manganese is the content as designed by the person skilled in the art to obtain the desired properties for the steel assuming the residuals do not have any effect on said properties. The desired properties are in-use properties such as mechanical properties or surface properties.

This invention permits to improve the processability of a steel by acting on its composition rather than the hot rolling process parameters. However, the object of this invention can be combined with a modification of the hot rolling process parameters, due to the presence of residual elements, such as the hot rolling temperature. As the steel is more ductile with an increase in temperature, increasing the hot rolling temperature can improve the processability of the steel without changing too much the composition.

### DETAILED DESCRIPTION

The composition in weight percent is the composition of the hot rolled steel product, wherein Mn_{t,a}=Mn₀+Mn_{ADD}=Mn_{t,I}−Mn_{RES}.

Mn_{t,a} is the adjusted target content in manganese which represents the real manganese content in the final product.

Mn_{t,i} is the initial target content in manganese which represents the theorical manganese content as designed by the person skilled in the art to obtain the desired properties of the steel without taking account of the effect of the residuals or supposing that there is no residual.

Mn₀ is the content of manganese resulting from step ii. during which steel scraps comprising at least one of said residual elements and optionally hot metal and/or direct reduced iron so as to form a steel melt.

Mn_{RES} is an adjustment term that represents the equivalent content of manganese having the same impact, as the content of said residual elements, on an increase of the mean flow stress resulting from the deformation applied during a hot rolling pass.

Mn_{ADD} is the content of molybdenum added at the step v., i.e. during the composition adjustment step.

Preferably, the hot rolled steel product comprises from 0.1 to 3.0 weight percent of manganese. Alternatively, the hot rolled steel product comprises from 3.0 to 12.0 weight percent of manganese.

In step ii., the steel melt is obtained by melting steel scraps comprising at least one of the following elements: Mo, Sn, Sb and As and optionally hot metal and/or direct reduced iron so as to form a steel melt.

For example, the steel scraps that can be used are referred to, in the EU-21 Steel Scrap specification, as old scraps (E1 or E3), new scraps (E8), shredded scraps (E40) or fragmentized scraps (E46).

This melting step, the step ii., can be done by any means deemed suitable by the person skilled in the art.

Preferably, it is performed by an electric arc furnace. More preferably, this electric arc furnace is fed with 10 wt. % to 100 wt. % of steel scrap, the remainder being direct reduced iron, and/or hot metal and/or any iron containing material. More preferably, this electric arc furnace is fed with 30 wt. % to 90 wt. % of steel scrap, the remainder being direct reduced iron, and/or hot metal and/or any iron containing material

Preferably, it is performed by a converter. More preferably, said converter is an oxygen converter. More preferably, said converter is charged with 50 to 500 kg of scrap per ton of hot metal and even more preferably, with 50 to 300 kg of scrap per ton of hot metal.

Preferably, it is performed by an open-hearth furnace. More preferably, said furnace is charged with 50 to 500 kg of scrap per ton of hot metal and even more preferably, with 50 to 300 kg of scrap per ton of hot metal.

In step iii., the content Mo₀, Sn₀, Sb₀, As₀ and Mn₀ is estimated and/or measured before the addition of manganese containing element of the step v.

Preferably, this estimation is done by means of sampling and/or by calculations using models. Sampling can be done before, during and after each step of the ladle metallurgy.

The step v. can also comprise the operation of deoxidizing the steel melt obtained in step ii. and can also permit to satisfy the required specifications in terms of composition, inclusion cleanliness, gas content (hydrogen, nitrogen) and temperature.

The step v., can be done by any means deemed suitable by the person skilled in the art.

Preferably, this composition adjustment step, the step v., is performed by ladle metallurgy. The ladle metallurgy can use one or more of the following devices: a ladle furnace, a stirring station, a vacuum tank degassing station, a desulphurisation station.

Preferably, the manganese content is adjusted by addition of ferro manganese and/or manganese ores and/or metal manganese.

In step i., an initial target composition is acquired. This composition specifies an initial target content of manganese Mn_{t,i} and the initial content for other elements desired in the final product. The content of each residual element in the initial target composition is equal to 0 or negligible. When it is said equal, it is to be understood that it is equal to more or less 10% of the value, preferably to more or less 5% of the value, more preferably to more or less 2% of the value.

In step iv., after the content of manganese Mn₀ and the content of each of the residual elements Mo₀, Sb₀, Sn₀, As₀ in the steel melt obtained at step ii., is estimated, an adjusted target composition is determined. This adjusted target composition specifies an adjusted target content of manganese Mn_{t,a}, which is calculated using the following formula: Mn_{t,a}=Mn_{t,I}−Mn_{RES}. The adjusted target composition takes into account the fact that, though non-desirable, some residuals turn out to be present in the steel melt; to this end, in the adjusted target composition, the residual contents are set to Mo₀, Sn₀, Sb₀ or As₀. For the other elements, their content is equal to the content in the initial target composition.

Mn_{RES} combines one or more corrective terms respectively associated to the one or more residual elements, the higher the estimated residual content for the residual element considered, the higher the corrective term is, each corrective term being a least equal to the estimated residual content for the residual element considered Mo₀, Sn₀, Sb₀ or As₀, or even at least equal to twice the estimated residual content for the residual element considered Mo₀, Sn₀, Sb₀ or As₀.

Preferably, Mn_{RES} combines the one or more corrective terms by adding together the one or more corrective terms.

Preferably, each of the one or more corrective terms is equal to an adjustment coefficient associated to the residual element considered times the estimated residual content for the residual element considered Mo₀, Sn₀, Sb₀ or As₀.

Preferably, Mn_{RES} is the sum of one or more of the a*Mo₀, b*Sn₀, c*Sb₀, d*As₀, wherein the adjustment coefficient a is from 2.25 to 3.38, the adjustment coefficient b is from 4.09 to 6.14, the adjustment coefficient c is from 17.08 to 25.62, the adjustment coefficient d is from 9.83 to 14.75.

Preferably, Mn_{RES} is being expressed as a function of the content of molybdenum, tin, antimony and arsenic. Even more preferably, Mn_{RES} is expressed as being equal to:

$${Mn}_{RES} = a * [ Mo ] + b * [ Sn ] + c * [ Sb ] + d * [ As ]$$

wherein [Mo] is the molybdenum content in weight percent, [Sn] is the tin content in weight percent, [Sb] is the antimony content in weight percent and [As] is the arsenic content in weight percent.

Even more preferably, a=2.82, b=5.12, c=21.35, d=12.29.

To calculate Mn_{RES}, the first step consists in using a physical model to calculate the flow stress of a steel without residuals, then defining, in another steel, a content for each residual element and calculating, using the same physical model, the content of Mn that allows said other steel to have the same flow stress as the steel without residuals. The physical model and the calculations can be done using the software JMatPro published by Sente Software. The use of the software for calculating the flow stress of a material is described in “Introduction of materials modelling into metal forming simulation” by Guo and al., paragraph 2.3, and “Deformation behavior and plastic instability of ultra-high strength low alloy steel over wide temperature and velocity range” by Farah and al., paragraph 3.1, for instance. The calculations can also be done using the physical model described in “A model to predict the austenite evolution during hot strip rolling of conventional and Nb microalloyed steels” by Perlade and al.

The calculations are repeated to obtain a database with Mn contents for different residual elements contents. A formula is then established using this database to obtain a value of Mn_{RES} as a function of one or more of the contents of the one or more residual elements.

### Experimental Results

The following section deals with simulations showing the impact of the present invention.

In each simulation, the initial target composition of the steel is: 0.1 weight percent of C, 1.9 weight percent of Mn (Mn), 0.2 weight percent of Si, 0.02 weight percent of Al and a balance consisting of Fe.

The contents of Mn and of residual elements at the end of step ii. are listed in Table 1.

For example, the steel melt D has 0.10 weight percent of molybdenum, 0.05 weight percent of tin, 0.03 weight percent of antimony, 0.04 weight percent of arsenic and 0.2 weight percent of manganese Mn₀ at the end step ii.

Mn_{RES} an adjustment term which represents an equivalent content of manganese having the same impact, as the content of said residual elements, on an increase of the mean flow stress resulting from the deformation applied during the last hot rolling pass can be calculated using the following formula:

$${Mn}_{RES} = 2.82 * [ Mo \% ] + 5.12 * [ Sn \% ] + 21.35 * \{ Sb \% ] + 12.29 * [ As \% ] = 2.82 * 0.1 + 5.12 * 0.05 + 21.35 * 0.03 + 12.29 * 0.04 = 1.67$$

Consequently, using the following formula: Mn_{t,a}=Mn₀+Mn_{ADD}=Mn_{t,i}−Mn_{RES}, a person skilled in the art deduce that: Mn_{ADD}=Mn_{t,i}−Mn₀−Mn_{RES}.

So Mn_{ADD}=1.9−0.2−1.67=0.03. The person skilled in the art can adjust the element contents to reach the composition defined hereabove and add an amount of manganese such that Mn_{ADD} is 0.03 weight percent of the composition.

Then a semi-finished product is cast and then hot rolled.

Considering the target composition and the rolling parameters at the last hot rolling stand that are listed in Table 1, the mean flow stress is of 173 MPa for the last active rolling stand when the impact of the residual elements is not taken into account.

However, when the residual elements are taken into account and if the adjustment of the manganese content does not take into account the presence of residual elements so that Mn_{ADD}=Mn_{t,I}−Mn₀, then the mean flow stress is of 196 MPa for the last active rolling stand. In other words, the residual elements lead to an increase of the mean flow stress of 23 MPa.

But as explained hereabove, when the residuals are taken into account, so that Mn_{ADD}=Mn_{t,I}−Mn₀−Mn_{RES}, then a reduced amount of manganese is added during the adjustment composition step. As a result, the increase of the mean flow stress due to the residual elements can be offset.

Consequently, the required mean flow stress for the last active rolling stand is the same as the one of the compositions when there are no residual elements.

TABLE 1

| | | | |
|---|---|---|---|
| Steel | Steel | Steel | Steel |
| melt A | melt B | melt C | melt D |

Content of the residual elements and Mn after the melting step

| | | | | |
|---|---|---|---|---|
| Mo [weight percent] | 0.13 | 0 | 0.10 | 0.10 |
| Sn [weight percent] | 0.05 | 0.05 | 0 | 0.05 |
| Sb [weight percent] | 0 | 0 | 0.03 | 0.03 |
| As [weight percent] | 0 | 0.03 | 0 | 0.04 |
| Mn₀ [weight percent] | 0.2 | 0.2 | 0.2 | 0.2 |

Manganese contents

| | | | | |
|---|---|---|---|---|
| Mn_{RES} | 0.62 | 0.62 | 0.92 | 1.67 |
| Mn_{ADD} | 1.08 | 1.08 | 0.78 | 0.03 |

Rolling parameters (hot rolling pattern)

| | | | | |
|---|---|---|---|---|
| Strain rate | 100 | 100 | 100 | 100 |
| Thickness before the last hot rolling stand | 3.2 | 3.2 | 3.2 | 3.2 |
| Thickness after the last hot rolling stand | 2.8 | 2.8 | 2.8 | 2.8 |

Mean flow stress

| | | | | |
|---|---|---|---|---|
| Mean flow stress without residual element | 173 | 173 | 173 | 173 |
| [MPa] | | | | |
| Mean flow stress with residual element | 182 | 181 | 185 | 196 |
| [MPa] if Mn_{ADD} = Mn_{t, i} − Mn₀ | | | | |
| Increase in Mean flow stress due to the | 9 | 8 | 12 | 23 |
| residual elements [MPa] | | | | |
| Mean flow stress with residual element | 173 | 173 | 173 | 173 |
| [MPa] if Mn_{ADD} = Mn_{t, i} − Mn₀ − Mn_{RES} | | | | |
| (according to the invention) | | | | |

What is claimed is:

1.-8. (canceled)

9. A method of manufacturing a hot rolled steel product having a composition in weight percent being: 0.002≤C≤0.8, 0.1≤Mn≤12.0, Si≤2, Al≤2, Cr≤0.5, Nb≤0.08, Ti≤0.1 and a balance consisting of Fe, one or more residual elements and unavoidable impurities, wherein said one or more residual elements comprise one or more of Mo, Sn, Sb, As, the method comprising the steps of:
i. acquiring an initial target composition specifying an initial target content of manganese Mn_{t,I};
ii. melting steel scraps comprising at least one of said one or more residual elements and optionally hot metal or direct reduced iron so as to form a steel melt;
iii. estimating an estimated content of manganese Mn₀ in the steel produced in step ii, and for each of the one or more residual elements: estimating an estimated residual content Mo₀, Sn₀, Sb₀ or As₀ of the steel melt produced in step ii.;
iv. determining an adjusted target composition which specifies an adjusted target content of manganese Mn_{t,a} where Mn_{t,a}=Mn_{t,I}−Mn_{RES} with Mn_{RES} an adjustment term which combines one or more corrective terms respectively associated to the one or more residual elements, the higher the estimated residual content for the residual element considered, the higher the corrective term, each corrective term being at least equal to the estimated residual content for the residual element considered Mo₀, Sn₀, Sb₀ or As₀;
v. adding elements to the steel melt so that Mn₀+Mn_{ADD}=Mn_{t,a}, wherein Mn_{ADD} represents the content of manganese added;
vi. casting a semi-finished product with the steel melt; and
vii. hot rolling said semi-finished product.

10. The method as recited in claim 9 wherein said step ii. is performed at least partially via an electric arc furnace.

11. The method as recited in claim 9 wherein each corrective content of Mn_{RES} is at least equal to twice the estimated residual content for the residual element considered Mo₀, Sn₀, Sb₀ or As₀.

12. The method as recited in claim 9 wherein Mn_{RES} combines the one or more corrective terms by adding together the one or more corrective terms.

13. The method as recited in claim 9 wherein each of the one or more corrective terms is equal to an adjustment coefficient associated to the residual element considered Mo₀, Sn₀, Sb₀ or As₀, multiplied by the estimated residual content for the residual element considered Mo₀, Sn₀, Sb₀ or As₀.

14. The method as recited in claim 13 wherein Mn_{RES} is the sum of one or more of the a*Mo₀, b*Sn₀, c*Sb₀, d*As₀, wherein:
the adjustment coefficient a is from 2.25 to 3.38,
the adjustment coefficient b is from 4.09 to 6.14,
the adjustment coefficient c is from 17.08 to 25.62, and
the adjustment coefficient d is from 9.83 to 14.75.

15. The method as recited in claim 14 wherein Mn_{RES} is calculated according to the formula: Mn_{RES}=a*[Mo]+b*[Sn]+c*[Sb]+d*[As], wherein [Mo] is the molybdenum content in weight percent, [Sn] is the tin content in weight percent, [Sb] is the antimony content in weight percent and [As] is the arsenic content in weight percent.
